(19) United States
(12) Patent Application Publication
(10) Pub. No.: US 2011/0310354 A1
(43) Pub. Date: Dec. 22, 2011

(54) MULTI-PROJECTION SYSTEM, PROJECTOR, AND METHOD OF CONTROLLING PROJECTION OF IMAGE

(75) Inventors: Toshiki Fujimori, Shimosuwa-machi (JP); Shun Imai, Matsumoto-shi (JP)

(73) Assignee: Seiko Epson Corporation, Tokyo (JP)

(21) Appl. No.: 13/158,522

(22) Filed: Jun. 13, 2011

(30) Foreign Application Priority Data
Jun. 17, 2010 (JP) 2010-137999

(51) Int. Cl. G03B 21/14

(52) U.S. Cl. 353/31; 353/97; 353/121

(57) ABSTRACT

A multi-projection system includes a first projector and a second projector. Each of the projectors includes: a light source; a modulation device that modulates light emitted by the light source; a projection device that projects light modulated by the modulation device; a brightness reduction device that reduces brightness of the projection image projected by the projection device; a color mode switching unit that changes a color mode of the projector; and a brightness reduction control device that adjusts a range for which brightness is reduced by the brightness reduction device in accordance with the change in the color mode of the projector.

The entire disclosure of Japanese Patent Application No. 2010-137999, filed Jun. 17, 2010 is expressly incorporated by reference herein.

### BACKGROUND

1. Technical Field

The present invention relates to a multi-projection system including a plurality of projectors, projector, and a method of controlling projection of an image.

2. Related Art

Generally, a multi-projection system that projects one image by using a plurality of projectors is known. In a system of this type, parts of the projection ranges overlap each other so as to prevent the boundary of the projection ranges of the projectors that are adjacent to each other to be observably distinct. Thus, in order to avoid the luminance of the overlapping portions being higher than that of the other portions, a configuration is proposed in which a light shielding device is arranged on a path through which light of the projectors pass, and the light projected to the overlapping portions is decreased (for example, JP-A-2001-268476).

Among projectors, there are projectors of a type having a plurality of color modes in which the hue and the luminance of a projected image is adjusted in accordance with the viewing purpose of the image. Although projectors of this type can be used in the above-described multi-projection system, a reduced-light state of the overlapping portions is not necessarily constantly appropriate in a case where the hue or the luminance is changed by changing the color mode. Accordingly, there is a possibility that the boundary of the projection range of each projector becomes observably distinct to give a viewer a sense of incongruity.

### SUMMARY

An advantage of some aspects of the invention is that it provides a multi-projection system using a plurality of projectors, which can project images in a plurality of color modes, capable of projecting a high-quality image that does not give a sense of incongruity even in a case where the color mode is changed.

According to a first aspect of the invention, there is provided a multi-projection system that includes a first projector and a second projector. Each of the projectors includes: a light source; a modulation device that modulates light emitted by the light source; a projection device that projects light modulated by the modulation device; a brightness reduction device that reduces brightness of projection image projected by the projection device; and a brightness reduction control device that adjusts a range for which brightness is reduced by the brightness reduction device in accordance with the change in the color mode of the modulation device.

According to the above-described multi-projection system, by adjusting the range for which brightness is reduced in accordance with the change in the color mode of the projector, the luminance and the hue of the overlapping areas formed by the projection images can be adjusted in accordance with the color mode. Accordingly, the projection is performed such that the overlapping areas are not observably distinct in any color mode, and a high-quality image causing no sense of incongruity can be projected even in a case where the color mode is changed.

In addition, according to the above-described multi-projection system, by transmitting an instruction from a color mode control device, the color modes of the plurality of the projectors may be changed to the same color mode altogether. In such a case, a situation can be prevented in which the color modes of the projectors are not uniform, and a sense of incongruity incurs. Accordingly, a high-quality image without causing any sense of incongruity can be projected even in a case where the color image is changed.

In addition, in the above-described multi-projection system, it may be configured such that the color modes of the plurality of the projectors are changed to the same color mode altogether by the color mode control device, and the brightness reduction state of each projector is adjusted in a speedy manner based on the information transmitted from the brightness reduction information control device to each projector. In such a case, the color modes of the plurality of the projectors can be changed to the same color mode altogether, and the range for which brightness is reduced can be adjusted in accordance with the color mode in a speedy manner. In addition, there is an advantage that the brightness reduction state corresponding to the color mode can be managed in an integrated manner by the brightness reduction information control device.

In addition, in the above-described multi-projection system, each projector may store a range for which brightness is reduced in association with the color mode and adjust the range for which brightness is reduced in correspondence with the color mode after change. In such a case, a device that manages data relating to the brightness reduction range is not needed, and the brightness reduction state can be adjusted in accordance with the change in the color mode in a speed manner.

In addition, in the above-described multi-projection system, light may be reliably reduced on the outer periphery of the projection image by using a light shielding device that shields the projection image for a range up to a predetermined position from the outer periphery and a light shielding control device that adjusts the light shielding position of the light shielding device. In such a case, the luminance and the hue of the overlapping area formed by the projection images can be adjusted in accordance with the color mode of the projector.

In addition, in the above-described multi-projection system, it may be configured such that a projection image having a rectangular shape is light-shielded by a light shielding plate for each side, and the light shielding plate corresponding to each side can be independently adjusted. Accordingly, in a case where the projectors are arranged so as to be aligned vertically and horizontally, a high-quality image can be projected by freely adjusting the light shielding position of each projector.

According to a second aspect of the invention, there is provided a projector includes: a light source; a modulation device that modulates light emitted by the light source; a projection device that projects light modulated by the modulation device; a brightness reduction device that reduces brightness of projection image projected by the projection device; and a brightness reduction control device that adjusts a range for which brightness is reduced by the brightness reduction device in accordance with the change in the color mode of the modulation device.

According to the above-described projector, in a case where an image is projected so as to form overlapping areas overlapping projection images of other projectors, by adjusting the luminance and the hue of the overlapping areas by reducing brightness of the projection image, the overlapping areas can be allowed to be visually indistinctive. In a case where the color mode is changed, since the brightness reducing range is adjusted in accordance with the color mode, the overlapping areas can be projected so as not to be observably distinct even in a case where the color mode is changed. Accordingly, by combining a plurality of the above-described projectors, a multi-projection system that can project a high-quality image such that the overlapping areas are not observably distinct can be realized.

According to a third aspect of the invention, there is provided a method of controlling projection of images onto a projection surface from a first projector and a second projector. In the method, brightness of projection image projected by each projector is reduced, and a range for which brightness is reduced is adjusted in accordance with the color mode of each of the projectors.

According to the above-described method, in a case where projection is performed by using a plurality of projectors, brightness is reduced for a predetermined range from the outer periphery of the projection image so as to allow the overlapping areas to be visually indistinctive. In addition, by adjusting the range for which brightness is reduced in accordance with the change in the color mode of the projector, brightness reduction state is adjusted in accordance with the color mode, whereby the luminance and the hue of the overlapping areas can be adjusted. Accordingly, projection is performed such that the overlapping areas are not observably distinct in any color mode, whereby a high-quality image causing no sense of incongruity can be projected even in a case where the color mode is changed.

According to the aspects of the invention, the overlapping area is not observably distinct even in a case where the color mode is changed, and accordingly, a high-quality image without causing any sense of incongruity can be projected.

### BRIEF DESCRIPTION OF THE DRAWINGS

The invention will be described with reference to the accompanying drawings, wherein like numbers reference like elements.

FIG. 1 is a schematic diagram showing the configuration of a multi-projection system according to an embodiment.

FIG. 2 is a schematic diagram showing the appearance of projection using a multi-projection system.

FIGS. 3A, 3B, and 3C are diagrams showing the operation states of a light shielding device.

FIG. 4 is a diagram showing the configuration of a projector and an image processing device.

FIG. 5 is a flowchart illustrating the operation of a projector.

FIG. 6 is a flowchart illustrating the operation of a projector according to a modified example.

### DESCRIPTION OF EXEMPLARY EMBODIMENTS

Hereinafter, an embodiment of the invention will be described with reference to the drawings.

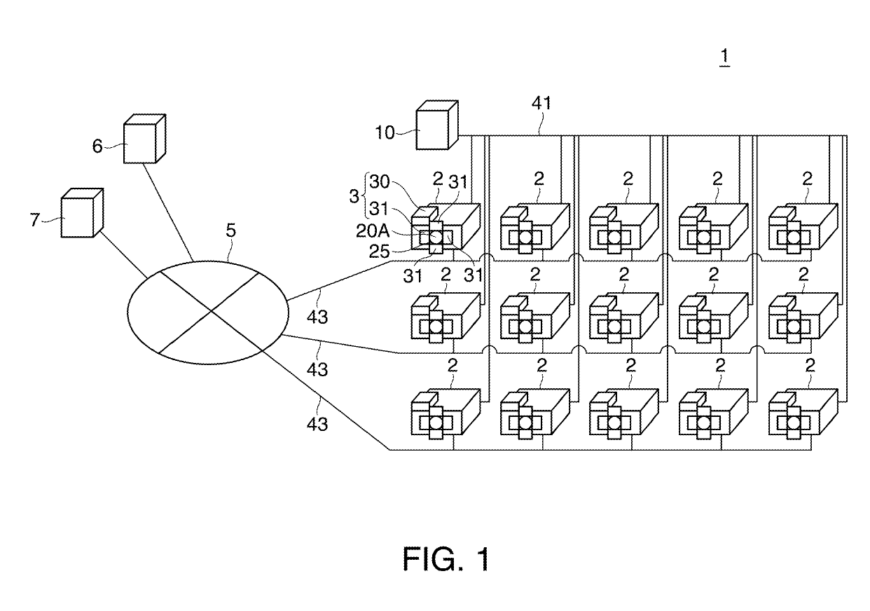

FIG. 1 is a schematic diagram showing the configuration of a multi-projection system 1 according to an embodiment of the invention.

The multi-projection system 1 shown in FIG. 1 is a system in which a plurality of projectors 2 are arranged so as to be aligned, projection images projected by the plurality of projectors 2 are combined, and one large-screen image is projected through tiling display. An image processing device 10 that outputs image data of an image to be projected to the projectors 2 is connected to the projectors 2 included in the multi-projection system 1 through image transmission cables 41.

The image processing device 10 divides an original image of the large-screen image projected by the multi-projection system 1 into blocks corresponding to the number of the projectors 2 and generates block image data to be projected by each projector 2. Then, the image processing device 10 outputs each set of generated block image data to the projector 2 arranged at a position corresponding to the block through the image transmission cable 41. Accordingly, each projector 2 only projects the image data input from the image processing device 10, thereby image projection through tiling can be performed overall by the multi-projection system 1.

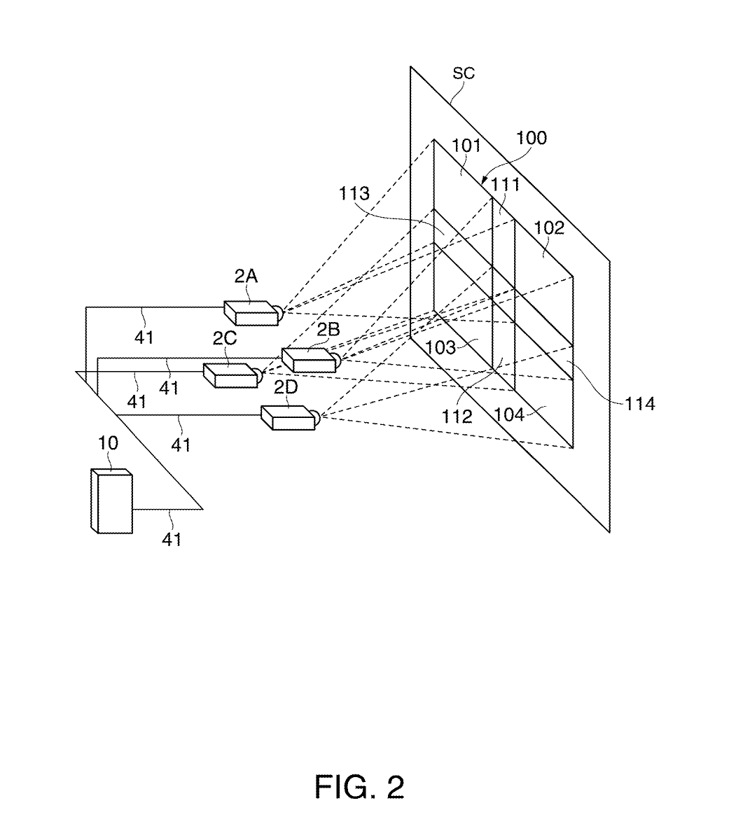

FIG. 2 is a schematic diagram showing the appearance of projection using the plurality of projectors 2.

FIG. 2 shows an example in which one projection image 100 is projected on a screen SC (projection surface) through tiling by using four projectors 2. In this example, a projector 2A projects an image on the upper left side of the screen SC, a projector 2B projects an image on the upper right side of the screen SC, a projector 2C projects an image on the lower left side, and a projector 2D projects an image on the lower right side. Here, the projection images projected by the projectors 2A, 2B, 2C, and 2D slightly overlap one another so as to prevent the boundaries formed through tiling on the screen SC to be observably distinct. In other words, a projection image 101 projected by the projector 2A and a projection image 102 projected by the projector 2B adjacent thereto on the right side have overlapping edges so as to form an overlapping area 111, as shown in the figure. Similarly, a projection image 103 projected by the projector 2C and a projection image 104 projected by the projector 2D adjacent to the projector 2C on the right side have overlapping edges so as to form an overlapping area 112. In addition, the projection images overlap each other also in the vertical direction so as to form overlapping areas 113 and 114.

The ranges in which the projectors 2A, 2B, 2C, and 2D project images on the screen SC are determined based on the distance between the screen SC and each of the projectors 2A, 2B, 2C, and 2D, a gap between adjacent projectors 2, and the angle of the optical axis of each of the projectors 2A, 2B, 2C, and 2D with respect to the screen SC. In other words, the projectors 2A, 2B, 2C, and 2D are previously installed at the positions and angles for forming the overlapping areas 111 to 114 on the screen SC.

The image processing device 10 divides a projection image 100 into four blocks, so that the projection image 100 can be projected using four projectors 2A, 2B, 2C, and 2D. Here, in consideration of the formation of the overlapping areas 111 to 114, ranges larger than a quarter of the projection image 100 are assigned to the projectors 2A, 2B, 2C, and 2D. The image processing device 10 outputs block image data corresponding to the assignments of the projectors 2A, 2B, 2C, and 2D to the projectors 2A, 2B, 2C, and 2D through the image transmission cables 41.

The image processing device 10 generates the block image data such that the projection image 101 and the projection image 102 are the same images in the overlapping area 111, and accordingly, a sharp image similar to that projected in other portions is projected onto the overlapping area 111. In addition, images are similarly projected onto the other overlapping areas 112 to 114. However, since light projected from a plurality of the projectors 2 is combined in the overlapping areas 111 to 114, the intensity of light therein is higher than that of the other areas, and consequently, the luminance of the overlapping areas 111 to 114 is higher than that of the other areas. Accordingly, the boundaries of the projection images of the projectors 2 are observably distinct. Thus, in the multi-projection system 1, in order to suppress the luminance of the overlapping areas 111 to 114 to be at the same level as that of other areas, a light shielding device 3 (brightness reduction device) is disposed in the projector 2. The light shielding device 3 reduces brightness of the projection image 100 by shielding the light emitted from the projectors 2.

In other words, as shown in FIG. 1, the projector 2 includes a light shielding device 3 that has a plurality of light shielding plates 31 arranged on the periphery of a projection optical system 25 from which projection light is output and a light shielding unit 30 that drives the light shielding plates 31. The light shielding plate 31 is a rectangular plate that is opaque or has low translucency, and four light shielding plates 31 are disposed in correspondence with the sides of the rectangular projection image projected by the projector 2. Each of the light shielding plates 31 is independently slid by the light shielding unit 30. Thus, the light shielding plate 31 can advance to the front side of the projection optical system 25 so as to block the projection image or move back up to a position at which the projection optical system 25 is not blocked so as not to have an effect on the projection image. By a plurality of the light shielding plates 31, a projection window 20A through which light projected from the projection optical system 25 can pass is formed.

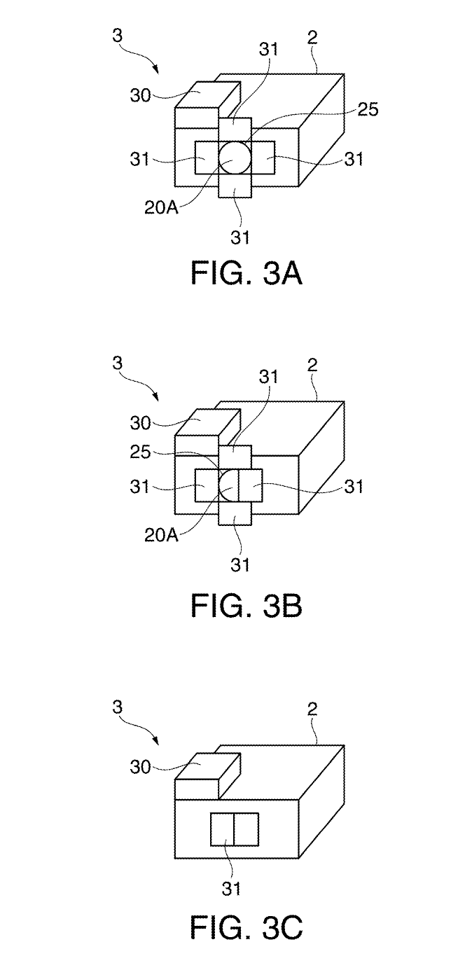

FIGS. 3A, 3B, and 3C show the operation states of the light shielding device 3 of the projector 2.

As shown in FIG. 3A, the four rectangular light shielding plates 31 included in the light shielding device 3 can move back up to a position at which the projection optical system 25 is not blocked at all so as to form a state in which the projection image is not blocked at all. In addition, as shown in FIG. 3B, by setting the light shielding position of the light shielding plate 31 to the center of the projection optical system 25 by independently driving only one light shielding plate 31, only one side of the projection image can be blocked up to an area near the center. Furthermore, by increasing the amount of movement of the light shielding plate 31, for example, as shown in FIG. 3C, a state can be formed in which the projection optical system 25 is completely covered.

As above, by moving the light shielding plate 31 using the light shielding unit 30 so as to block the projection optical system 25, the projector 2 shields a part of the light projected from the projection optical system 25 and performs light shielding of the edge portion of the projection image. Accordingly, the light intensity in the edge portion of the projection image projected by each projector 2 decreases. Therefore, the luminance of the overlapping areas 111 to 114 shown in FIG. 2 can be suppressed so as to be at the same level as that of the other portions, whereby the boundaries of the tiling can be visually indistinctive.

In the projector 2 according to this embodiment, the amount of light shielding using the light shielding device 3 can be represented by a position up to which the light shielding plate 31 advances or the position of the front end thereof. Hereinafter, the position of the front end of the light shielding plate 31 is represented as a light shielding position. This light shielding position, as will be described later, is determined based on the position of the projection optical system 25.

As shown in FIG. 2, in a case where a plurality of the projectors 2 is aligned, the positional relationships between the projection images 101 to 104 and the overlapping areas 111 to 114 differ for the projection images 101 to 104. In other words, the right end and the lower end of the projection image 101 projected by the projector 2A are overlapping areas, and the left end and the upper end of the projection image 104 projected by the projector 2D are overlapping areas. Accordingly, a preferred light shielding position for allowing the boundary of the tiling to be visually indistinctive differs for each projector 2, and the preferred light shielding position also differs for each side of the light shielding plate 31 in one projector 2. Therefore, the projector 2 adjusts the light shielding position in accordance with the position thereof in the group of the projectors 2 included in the multi-projection system 1, and the light shielding device 3 adjusts the light shielding position by independently using the four light shielding plates 31.

In addition, the projector 2 according to this embodiment has a plurality of color modes and can project an image by switching the current color mode between the color modes. A color mode is a state in which a projection image is projected with specific hue and/or specific luminance. Accordingly, in a color mode and another color mode, the hue and/or the luminance of the projection image are different. This color mode can be selected by a user in accordance with the characteristics of the projection image and the surrounding environments, and the like. In a color mode, a state is included in which the input image data is projected without any change. Specific examples of the color mode include a theater mode in which the hue and the luminance of input image data are adjusted so as to be appropriate for watching a movie by darkening the surrounding of the screen, a dynamic mode in which the hue and the luminance of input image data are adjusted such that even though the surrounding of the screen is bright, an image can be clearly visually recognized, and a normal mode in which the input image data is projected without correcting, particularly, the hue and the luminance thereof. Although the projector 2 can perform projection by switching the current mode between the color modes, the multi-projection system 1 performs tiling projection using a plurality of the projectors 2. Accordingly, in a case where the color modes of the projectors 2 are different from each other, the whole projection image gives a sense of incongruity. Thus, the multi-projection system 1, as will be described later, performs such a control operation that the color modes of all the projectors 2 are the same.

As shown in FIG. 1, each projector 2 is connected to a network 5 through a communication line 43. Here, the communication line 43 may be a cable that connects the projector 2 to the network 5 in a wired manner or a wireless communication channel that is formed by a wireless communication module that is externally connected to the projector 2 or is built therein.

The network 5 is a two-way communication network such as a LAN (Local Area Network) that is configured by a wired line or a wireless communication channel, and a color mode control server 6 and a control server 7 are connected to the network 5 together with each projector 2.

The color mode control server 6 (color mode control device) can transmit control information to each projector 2 through the network 5 and transmits control information used for instructing all the projectors 2 to change the color mode when the color mode of the projectors 2 is changed.

When the control information used for instructing to change the color mode is transmitted to each projector 2 by the color mode control server 6, the control server 7 (a brightness reduction information control device) transmits control information used for adjusting the light shielding device 3 in accordance with the color mode of the projectors 2 after change. As described above, since the light shielding position differs for each projector 2 and for each light shielding plate 31, the control server 7 transmits to each projector 2 the control information representing an optimal light shielding position of the projector 2, and this control information includes information that is used for individually designating the light shielding position of each light shielding device 3 included in the projector 2.

As described above, the projector 2 can switch the current color mode between a plurality of color modes. However, since the hue and the luminance differ in each color mode, a preferred light shielding position that allows the boundaries of tiling not to be observably distinct differs in accordance with the color mode. For example, in the above-described dynamic mode, in order to allow the surrounding of the screen SC to be bright and an image to be sharply visible, the overall luminance of the projection image 100 is high. Accordingly, in a case where the luminance of the overlapping area is high, the overlapping area is not easily observably distinct, and in a case where the luminance of the overlapping area is lower than that of other areas, the overlapping area is observably distinct. Thus, in the dynamic mode, it is preferable that the light shielding position is set to a position on the front side of the projection optical system 25, that is, a position on the outer side of the range in which the projection optical system 25 projects light so as to decrease the amount (light shielding amount) of shielding of projection light used for projecting an image by the projector 2. To the contrary, in the above-described theater mode, the overall luminance of the projection image 100 is suppressed in accordance with the dark state of the surrounding of the screen SC, and accordingly, in a case where the luminance of the overlapping area is high, the boundaries can be easily observably distinct. Therefore, in the theater mode, in order to increase the light shielding amount, it is preferable that the light shielding position is close to the center on the front side of the projection optical system 25. In addition, by physically shielding light by advancing the light shielding plate 31 to the front side of the projection optical system 25, there is a case where light tinged with blue or red appears in the edge portion of the projection image, that is, the overlapping area due to the influence of the optical characteristics of the projector 2. In a case where such a tinge of color is clearly different from the hue of each color mode, the overlapping area may be easily observably distinct.

Thus, in the multi-projection system 1 according to this embodiment, by transmitting the control information from the control server 7 to each projector 2, a preferred light shielding position of the light shielding device 3 is set for each color mode, and the light shielding position is changed in a case where the color mode is changed.

In this embodiment, the control server 7 stores data, which represents the light shielding position for each color mode, for each projector 2 in advance. When the color mode is changed, the color mode control server 6 transmits control information used for instructing the projectors 2 and the control server 7 to change the color mode, and the control server 7 receives this control information and individually transmits control information used for designating the light shielding position of the light shielding plate 31 that is appropriate for the color mode after change to the projectors 2.

The control information that is transmitted from the control server 7 to the projector 2 may be either absolute-position designating information that is used for designating the absolute position of the light shielding plate or relative-position designating information that represents a relative movement amount with respect to the current position of the light shielding plate 31 as a reference.

The light shielding unit 30 included in the projector 2 controls the light shielding position of the light shielding plate 31 as a movement amount from a reference position. For example, the light shielding unit 30 sets a position of the light shielding plate 31 that is farthest from the center (the axial center of the area in which the projection optical system 25 projects light) of the projection optical system 25 as a reference position (position 0) and sets the amount of movement from this reference position toward the center of the projection optical system 25 as a value representing the light shielding position.

As an example, a case will be described in which the color mode is changed to the theater mode in a multi-projection system 1 that is in the middle of a projection operation in the normal mode. In a case where the absolute position designating information is used, the control server 7 transmits control information that is used for designating the position of the light shielding plate 31 of the theater mode as a color mode after change, and the light shielding unit 30 of the projector 2 moves the light shielding plate 31 to a position represented by the received control information. On the other hand, in a case where the relative position designating information is used, the control server 7 compares the light shielding position of the normal mode before change with the light shielding position of the theater mode after change and transmits control information representing a difference thereof to the projector 2. The light shielding unit 30 moves the light shielding plate 31 by the amount represented by the received control information with respect to the current light shielding position of the light shielding plate 31 as a reference. In a case where the absolute position designating information is used, the control server 7 reads out data of the light shielding position corresponding to the color mode after change and transmits the data directly to the projector 2. Accordingly, there are advantages that the processing load of the control server 7 is light, and the control information can be transmitted to a plurality of the projectors 2 at high speed. On the other hand, in a case where the relative position designating information is used, each projector 2 moves the light shielding plate 31 from the current position by the amount represented by the received control information. Therefore, the processing load of the projector 2 is light, each projector 2 can change the light shielding position in a speedy manner, and accordingly, there is an advantage that the overlapping areas cannot be easily observably distinct further.

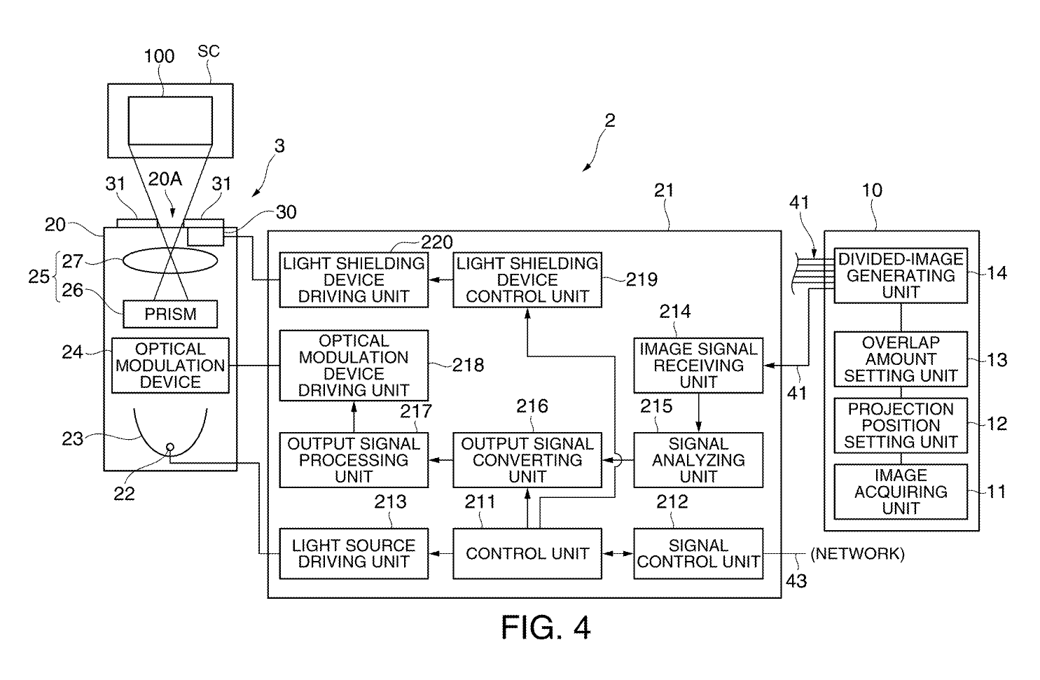

FIG. 4 is a diagram showing the functional configuration of the image processing device 10 and the projector 2, and the hardware configuration of the projector 2 is schematically shown as well.

The image processing device 10 includes: an image acquiring unit 11 that acquires image data of a projection image 100 that is projected by the projectors 2; a projection position setting unit 12 in which the projection position of each projector 2 is set; an overlap amount setting unit 13 in which the position and the size of the overlapping area are set; and a divided-image generating unit 14 that generates block image data projected by each projector 2.

The image acquiring unit 11 acquires image data stored in a built-in storage device or image data input from an external video source device. To each projector 2 of the multi-projection system 1, unique identification information is assigned. In addition, the identification information of each projector 2 and the positional relationship of the projectors 2 are set in the projection position setting unit 12. The projection position setting unit 12 outputs the information representing the setting state to the overlap amount setting unit 13.

In the overlap amount setting unit 13, the identification information of each projector 2 and the position and the size of an area (overlapping area) of an image, which is projected by each projector 2, overlapping the projection image of an adjacent projector 2 are set with being associated with each other. This setting may be input to the overlap amount setting unit 13 in advance from an external device so as to be stored in the overlap amount setting unit 13 or may be configured to be calculated by the overlap amount setting unit 13 based on information input from the projection position setting unit 12. The overlap amount setting unit 13 outputs the information input from the projection position setting unit 12 and information representing the position and the size of the overlapping area of the image projected by each projector 2 to the divided-image generating unit 14.

The divided-image generating unit 14 divides the image data acquired by the image acquiring unit 11 into data corresponding to the number of the projectors 2 based on the information input from the overlap amount setting unit 13 and generates block image data by expanding the divided image data by an amount corresponding to the overlapping area. Then, the divided-image generating unit 14 outputs the generated block image data to each projector 2. In addition, a configuration maybe employed in which image transmission cables 41 dedicated to the projectors 2 corresponding to the number of the projectors 2 are connected to the image processing device 10, or a configuration may be employed in which a plurality of the projectors 2 is connected to the image processing device 10 through a common image transmission cable 41. In the latter configuration, the image processing device 10 transmits the block image data with the identification information of the projector 2 being added thereto, and the projector 2 receives and projects only the block image data to which the identification information thereof is added.

The projector 2 includes: a lamp 22 that includes a reflector 23; an optical modulation device 24 (modulation device) that modulates light emitted by the lamp 22; a projection optical system 25 that projects the light modulated by the optical modulation device 24 toward a screen SC; and a control device 21 that controls the above-described units in a man body 20.

As the lamp 22 serving as a light source, for example, a xenon lamp, an ultra-high pressure mercury lamp, an LED, a laser, or the like may be used, and the lamp 22 may include a lens group (not shown), a polarizing plate, an auxiliary reflector (not shown), and the like that are used for improving the optical characteristics of the projection light, in addition to the reflector 23. In addition, a configuration acquired by combining the lamp 22 and the optical modulation device 24 may be replaced by a laser beam source and a scanning mechanism that scans laser beams.

The optical modulation device 24, for example, is configured by a system using three transmission-type or reflection-type liquid crystal light valves corresponding to colors RGB, a system combining one liquid crystal light valve and a color wheel, a DMD system using three digital mirror devices, a system combining one digital mirror device and a color wheel, or the like. In addition, the projection optical system 25 (projection device) includes a prism 26 that composes modulation light of three colors RGB that are modulated by the optical modulation device 24 and a lens 27 that forms the projection image composed by the prism 26 onto the screen SC. The prism 26 is configured by combining one or a plurality of optical prisms or mirrors in accordance with the configuration of the optical modulation device 24. In this embodiment, as the optical modulation device 24, three liquid crystal light valves are included, and the light modulated by the three liquid crystal light valves is configured to be composed by the prism 26. In a case where only one liquid crystal light valve or the DMD is used as the optical modulation device 24, a member corresponding to the prism 26 is not necessary.

The lens 27, for example, is configured by a plurality of lens groups and is driven by a driving mechanism (not shown) that adjusts the focus.

In addition, on the periphery of the projection optical system 25, light shielding plates 31 are arranged, and a light shielding unit 30 that individually drives the light shielding plates 31 is disposed.

The control device 21 includes a communication control device 212 that is connected to the communication line 43 and receives the control information transmitted from the color mode control server 6 and the control server 7 and a control unit 211 that controls each unit based on the control information received by the communication control device 212. The control unit 211 performs control of turning the lamp 22 of the main body 20 on/off, control of drawing in the optical modulation device 24, and control of shielding light using the light shielding unit 30. In other words, when the switch of the projector 2 is turned on, and projection image data is input from the image processing device 10, the control unit 211 turns on the lamp 22 by controlling a light source driving unit 213 that supplies power to the lamp 22. The control unit 211 sets the color mode based on the control information received by the communication control device 212, controls the optical modulation device 24 for projecting an image in the set color mode, performs control for adjusting the light shielding position of the light shielding plate 31 using the light shielding unit 30.

The control device 21 includes: an image signal receiving unit 214 that receives the block image data input from the image processing device 10; a signal analyzing unit 215 that analyzes the block image data received by the image signal receiving unit 214 and generates projection image data corresponding to the number of display pixels of the optical modulation device 24; an output signal converting unit 216 that adjusts the hue and the luminance of the projection image data generated by the signal analyzing unit 215 in accordance with the color mode designated by the control unit 211; an output signal processing unit 217 that generates a driving signal used for driving the optical modulation device 24 based on the projection image data the color mode of which is adjusted by the output signal converting unit; and an optical modulation device driving unit 218 that modulates the projection light by driving the optical modulation device 24 based on the driving signal generated by the output signal processing unit 217.

In addition, the control device 21 includes a light shielding control unit 219 that generates a driving signal used for operating the light shielding unit 30 under the control of the control unit 211 and stores the current light shielding position of the light shielding plate 31 and a light shielding device driving unit 220 that drives the light shielding unit 30 based on the driving signal generated by the light shielding control unit 219. By operating the control unit 211, the light shielding control unit 219, and the light shielding device driving unit 220, the control device 21 serves as a brightness reduction control device and alight shielding control device.

The light shielding plate 31 is supported by a rail not shown in the figure so as to overlap the front side of the projection optical system 25 and slide so as to be able to advance or retreat toward the center of the projection optical system 25. The light shielding unit 30, for example, includes a driving mechanism (not shown) that moves the light shielding plate 31 and a stepping motor (not shown) that operates the driving mechanism, and the light shielding device driving unit 220 outputs a driving pulse to the stepping motor included in the light shielding unit 30. Furthermore, the light shielding unit 30 may be configured to include a motor, an actuator, and a linear encoder that detects the position of the light shielding plate 31. In such a case, the light shielding device driving unit 220 supplies a driving current to the motor of the light shielding unit 30 or the actuator and detects the position of the light shielding plate 31 by using the linear encoder.

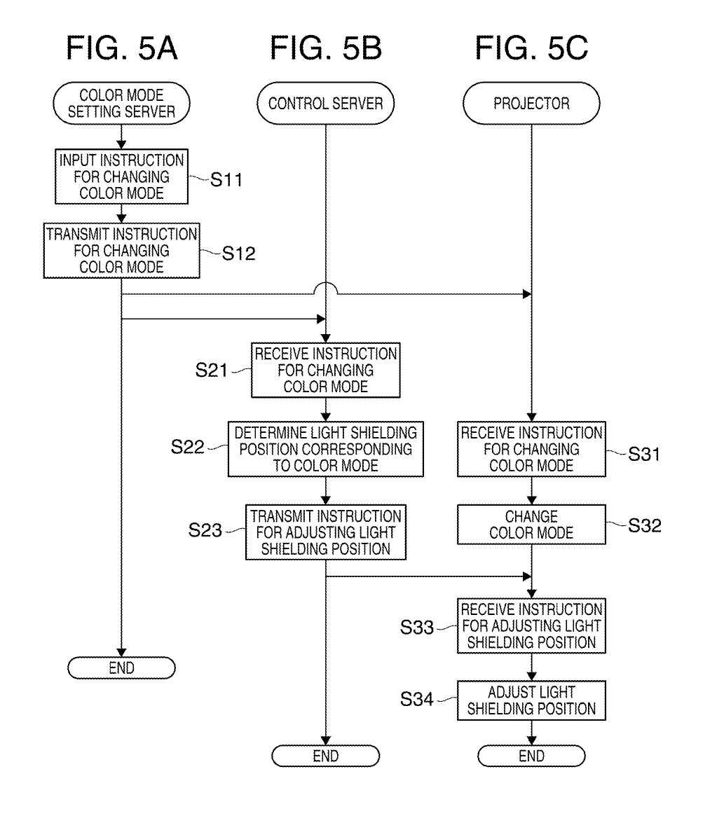

FIG. 5 is a flowchart illustrating the operation, which relates to the changing of the color mode, of the multi-projection system 1. (A) in FIG. 5 illustrates the operation of the color mode control server 6, (B) in FIG. 5 illustrates the operation of the control server 7, and (C) in FIG. 5 illustrates the operation of the projector 2.

In a case where the color mode is changed, an instruction for changing the color mode is input to the color mode control server 6 (Step S11). The instruction for changing the color mode may be made by using a method in which, in a case where one projector 2 is instructed to change the color mode, the projector 2 transmits an instruction for changing the color mode to the color mode control sever 6, a method in which a terminal device (not shown) used for instructing to change the color mode is connected to the network 5, and an instruction for changing the color mode is transmitted to the color mode control server 6 in accordance with the operation of the terminal device, and the like, in addition to a method in which an operator inputs the instruction for changing the color mode by directly operating the color mode control server 6.

When the instruction for changing the color mode is input, the color mode control server 6 generates control information that represents the change to the instructed color mode and transmits the generated control information to all the projectors 2 and control server 7 (Step S12).

The projector 2 receives the control information transmitted from the color mode control server 6 (Step S31) and changes the color mode in accordance with the control information (Step S32).

Meanwhile, the control server 7 receives the control information transmitted from the color mode control server 6 (Step S21), specifies the color mode after the change instructed based on the received control information, and determines the light shielding position of each projector 2 that corresponds to the specified color mode (Step S22). This determination, for example, is performed by reading out the light shielding position that is stored in association with the specified color mode for each projector 2. The control server 7 transmits control information used for instructing the adjustment of the light shielding position to each projector 2 (Step S23), and each projector 2 receives the control information (Step S33) and adjusts the light shielding position of the light shielding plate 31 by driving the light shielding unit 30 based on the received control information (Step S34).

As above, according to the multi-projection system 1 of the embodiment of the invention, in the multi-projection system 1 that projects images onto the screen SC from a plurality of the projectors 2 such that projection images projected from the projectors 2 that are adjacent to each other form an overlapping area, each projector 2 is configured so as to be able to switch the current color mode between a plurality of color modes and includes: an optical modulation device 24 that modulates light emitted from the lamp 22; a projection optical system 25 that projects light modulated by the optical modulation device 24; a light shielding device 3 that shields light in the range up to a predetermined position (a light shielding position within the projection image) from an outer periphery of the projection image projected by the projection optical system 25; and a control device 21 that adjusts the range in which the light shielding device 3 shields light, that is, the light shielding position of the light shielding device 3 in accordance with the change in the color mode of the projector 2. Accordingly, the light shielding position is adjusted in accordance with the change in the color mode of the projector 2, and the projection image is shielded with a light shielding amount corresponding to the color mode, whereby the luminance of the overlapping area formed by the projection images can be adjusted. Therefore, the projection is performed such that the overlapping areas are not observably distinct in any color mode, whereby an image having high quality can be projected without causing any sense of incongruity even when the current color mode switched between color modes.

In addition, the multi-projection system 1 includes the color mode control server 6 that transmits an instruction for switching to the same color mode to all the projectors 2, and each projector 2 changes the color mode of the projector 2 in accordance with the instruction transmitted from the color mode control server 6. Accordingly, since the color modes of all the projectors 2 can be changed to the same color mode altogether, a situation can be prevented in which the color modes of the projectors 2 are not uniform so as to cause a sense of incongruity, whereby an image having high quality that does not cause any sense of incongruity even in a case where the color mode is changed can be projected.

Furthermore, the control server 7 transmits control information representing the light shielding position corresponding to the color mode after the change to each projector 2, and the control device 21 of the projector 2 switches the color mode of the projector 2 based on the control information transmitted from the color mode control server 6 and adjusts the light shielding position of the light shielding device 3 based on the control information transmitted from the control server 7. Accordingly, the color modes of the plurality of the projectors 2 can be switched to the same color mode altogether, and each projector 2 can adjust the light shielding position in a speedy manner. Furthermore, the light shielding position for each color mode can be managed in an integrated manner by the control server 7.

In addition, the light shielding device 3 includes the light shielding plate 31 that can advance or retreat to the inside of the projection image from the outer side of the range in which the projection optical system 25 projects the projection image for each side of the rectangular projection image projected by the projection optical system 25 and independently adjusts the front end position of the light shielding plate 31 for each side of the rectangular projection image. Accordingly, the rectangular projection image can be shielded for each side, and therefore, in a case where the projectors 2 are arranged by being aligned horizontally and vertically, the luminance or the color tone of the overlapping areas can be freely adjusted, whereby images can be projected with high quality.

The projector 2 includes: an optical modulation device 24 that is configured so as to switch the color mode between a plurality of color modes and modulates the light emitted by the lamp 22; the projection optical system 25 that projects the light modulated by the optical modulation device 24; the light shielding device 3 that shields light a range up to the light shielding position within the projection image from the outer periphery of the projection image projected by the projection optical system 25; and the control device 21 that adjusts the light shielding position of the light shielding device 3 in accordance with the change in the color mode of the projector 2. By combining a plurality of the projectors 2, the multi-projection system 1 that can project a high-quality image without the overlapping areas being observably distinct can be realized.

In addition, in the above-described embodiment, a configuration has been described as an example in which the light shielding position corresponding to the color mode to which the color mode of the projector 2 can be switched is stored in the control server 7, and the light shielding position is transmitted from the control server 7 to the projector 2. However, the embodiment of the invention is not limited thereto, and a configuration may be employed in which the light shielding position for each color mode is stored in the projector 2. Hereinafter, such a case will be described as a modified example.

### MODIFIED EXAMPLE

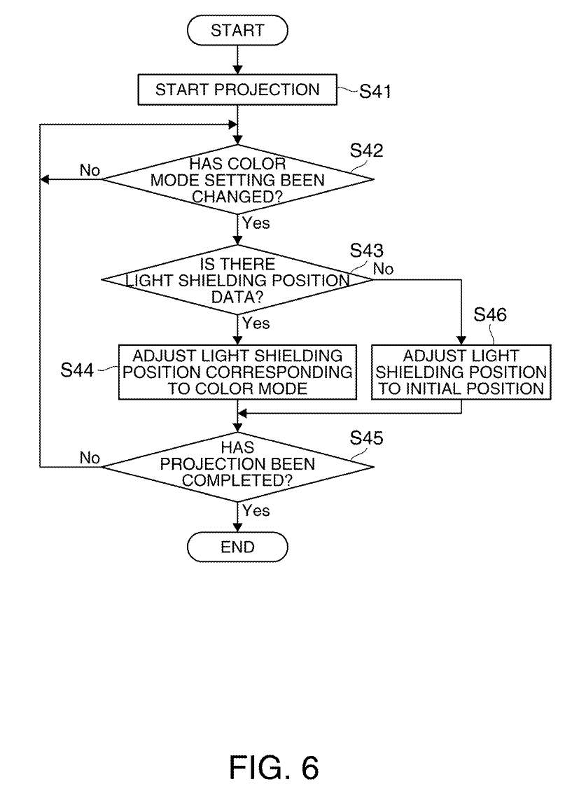

FIG. 6 is a flowchart illustrating the operation of the projector 2 according to a modified example.

In this modified example, in the above-described multi-projection system 1, the light shielding position for each color mode that is stored in the control server 7 is stored in the individual projectors 2. In each projector 2, the arrangement position of the projector 2 in all the projectors 2 and the light shielding position for each color mode that corresponds to the position are set in advance, and the set values are stored in the control device 21.

The projector 2 starts to project an image onto the screen SC (Step S41) and waits until the control information used for instructing to change the color mode is received from the color mode control server 6 (Step S42). When the control information used for instructing to change the color mode is received (Step S42; Yes), the projector 2 determines whether or not data of the light shielding position corresponding to the instructed color mode is stored in the control device 21 (Step S43). In a case where the light shielding position is stored, the projector 2 drives the light shielding unit 30 in accordance with the light shielding position so as to adjust the position of the light shielding plate 31 (Step S44). Thereafter, until the projection is completed (Step S45), the projector 2 returns the process back to Step S42 and repeats the process. On the other hand, in a case where the light shielding position corresponding to the change color mode is not stored (Step S43; No), the position of the light shielding plate 31 may be adjusted to the initial position set in advance (Step S46).

According to this configuration, each projector 2 stores the light shielding position corresponding to the color mode, and the projector 2 adjusts the light shielding position in correspondence with the color mode after the change when the color mode is changed. Accordingly, a device that manages the data of the light shielding positions is not needed, and the light shielding position can be adjusted in a speedy manner in accordance with the change in the color mode.

In this embodiment and the modified example thereof, a configuration has been described in which the light shielding plate 31 is disposed on the front side of the main body 20 on which the projector 2 includes the projection optical system that emits projection light of the projection image. However, the embodiment of the invention is not limited thereto. Thus, it may be configured such that the light shielding plate 31 is built in the main body 20 of the projector 2 and is disposed at a position that blocks the projection light passing through the projection optical system 25 or between the projection optical system 25 and the projection window 20A.

In addition, in the embodiment and the modified example described above, as a configuration example of the brightness reduction device, the light shielding device 3 that moves four light shielding plates 31 toward the projection optical system 25 has been described as an example. However, the embodiment of the invention is not limited thereto. Thus, the optical modulation device 24 instead of a plate-shaped member such as the light shielding plate 31 may reduce the light projected onto the edge of the projection image, so that the optical modulation device 24 is used as the brightness reduction device.

In other words, the luminance of the overlapping areas of the multi-projection system 1 may be adjusted by reducing the light projected onto the outer periphery portion of the projection image by decreasing the gray scale value for the edge portion of the optical modulation device 24, so that the overlapping areas are not allowed to be observably distinct even in a case where color mode of the projector 2 is changed. In such a case, when not only the luminance but also the hue for the overlapping areas is adjusted in the outer periphery of the optical modulation device 24, the luminance and the hue of the overlapping areas are adjusted, whereby the overlapping areas are not allowed to be observably distinct further. In this configuration, the control unit 211 adjusts the gray scale value and the luminance of the optical modulation device 24 by controlling the output signal converting unit 216. According to this configuration, similarly to the case where the light shielding plate 31 advances, the projection optical system 25 reduces light projected onto the outer periphery portion of the projection image projected by the projection optical system 25 without using hardware such as a light shielding plate 31, whereby the luminance and the hue in the overlapping areas are adjusted so as to be able to project a high-quality image.

In addition, the multi-projection system 1 may have a configuration in which the projector 2 is disposed on the front side of the screen SC, and reflection light reflected from the screen SC is observed on the front side of the screen SC or a configuration in which the projector 2 is disposed on the rear side of the screen SC, and transmission light transmitted from the screen SC is observed on the front side of the screen SC. Furthermore, the number of the projectors 2 included in the multi-projection system 1 is arbitrary, and the color mode control server 6 and the control server 7 may be configured by one computer, and other detailed configurations may be arbitrarily changed.

What is claimed is:

1. A multi-projection system comprising:
a first projector; and
a second projector;
wherein each of the projectors includes:
a light source;
a modulation device that modulates light emitted by the light source;
a projection device that projects light modulated by the modulation device;
a brightness reduction device that reduces brightness of projection image projected by the projection device;
a color mode switching unit that changes a color mode of the projector; and
a brightness reduction control device that adjusts a range for which brightness is reduced by the brightness reduction device in accordance with the change in the color mode of the projector.

2. The multi-projection system according to claim 1, further comprising a color mode control device that transmits an instruction for switching to a same color mode to all the projectors,
wherein the color mode switching unit changes the color mode of the projector in accordance with the instruction transmitted from the color mode control device.

3. The multi-projection system according to claim 2, further comprising a brightness reduction information control device that transmits information used for designating a brightness reduction state corresponding to the color mode after the change to the projector,
wherein the projector changes the color mode of the projector in accordance with the instruction transmitted from the color mode control device and adjusts the range for which brightness is reduced by the brightness reduction device based on the information transmitted from the brightness reduction information control device.

4. The multi-projection system according to claim 1, wherein the projector stores a range for which brightness is reduced in association with each color mode in advance and adjusts the range for which brightness is reduced by the brightness reduction device to the range corresponding to the color mode after change by using the brightness reduction control device in a case where the color mode of the projector is changed.

5. The multi-projection system according to claim 1,
wherein the brightness reduction device is a light shielding device that shields light for a range up to a light shielding position within the projection image from the outer periphery of the projection image projected by the projection device, and
wherein the brightness reduction control device is configured by a light shielding control device that adjusts the light shielding position of the light shielding device.

6. The multi-projection system according to claim 5, wherein the light shielding device includes a light shielding plate that can advance or retreat within the projection image from an outer side of the projection image for each side of the projection image, which has a rectangular shape, projected by the projection device and independently adjusts a front end position of the light shielding plate for each side of the projection image having the rectangular shape.

7. The multi-projection system according to claim 1, wherein the brightness reduction device reduces brightness of the projection image from an outer periphery of the projection image.

8. A projector comprising:
a light source;
a modulation device that modulates light emitted by the light source;
a projection device that projects light modulated by the modulation device;
a brightness reduction device that reduces brightness of projection image projected by the projection device;
a color mode switching unit that changes a color mode of the projector; and
a brightness reduction control device that adjusts a range for which brightness is reduced by the brightness reduction device in accordance with the change in the color mode of the projector.

9. A method of controlling projection of images onto a projection surface from a first projector and a second projector, the method comprising:
changing the color mode of each of the projectors; and
reducing brightness of projection image projected by the projectors, a range for which brightness is reduced being adjusted in accordance with the color mode of each of the projectors.
